(19) United States
(12) Patent Application Publication
(10) Pub. No.: US 2006/0220274 A1
(43) Pub. Date: Oct. 5, 2006

(54) APPARATUS AND METHOD FOR MAKING AN AUTOMOTIVE DOOR TRIM PANEL WITH A WRAPPED TURN DOWN FLANGE

(76) Inventors: David Dooley, Troy, MI (US); Matthew S. Brummer, Canton, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/907,453

(22) Filed: Apr. 1, 2005

(51) Int. Cl. B29C 45/14

(52) U.S. Cl. 264/259; 425/112; 425/554; 425/468; 264/328.7

(57) ABSTRACT

A mold assembly for forming an automotive trim panel includes a first mold section having a mold cavity, a mold core moveable relative to the first mold section, a flange lifter having a recess and capable of movement relative to the mold core and first mold section, and a flange slide selectively engagable with the flange lifter. A cover material is placed in the mold cavity and the flange lifter placed in a molding position to define a first mold chamber portion. The flange slide is engaged with the flange lifter to position the cover material in the recess and to define a second mold chamber portion in communication with the first mold chamber portion. The second mold chamber portion defines the turn down flange. A polymeric material is injected into the mold cavity and the mold core is moved to compress the material into the first and second mold chamber portions.

### FIELD OF THE INVENTION

The present invention pertains generally to trim assemblies for vehicle interiors, and more particularly to an apparatus and method of making a door trim panel having a wrapped turn down flange.

### BACKGROUND OF THE INVENTION

It is known to provide vehicle interiors with various trim assemblies to enhance the aesthetic appearance of the interior and to provide comfort, as well as convenience, to vehicle occupants. For example, vehicle door constructions typically feature a metal door frame with a sheet metal outer panel or skin that defines the door's exterior and an inner sheet metal panel secured to the door frame. Various door components, including window regulator rails, audio speakers, latches, and the like, are fastened in openings defined in the inner sheet metal panel. Covering the inner door panel is a removable trim panel that provides an aesthetically pleasing façade viewed by occupants seated in the passenger cabin of the motor vehicle. Controls are provided on the trim panel for devices such as seats, door locks, mirror and windows. The door latch is connected by a cable to an inner release handle on the trim panel accessible to the vehicle occupant.

Door trim panels have previously been constructed as unitary structures having individual components integrally formed with the panel or as assemblies in which individual components are assembled together and attached to the panel by several different conventional processes including adhesives, heat staking, sonic welding, fasteners, etc. Such trim panels may include various trim components such as door trim bolsters, armrests, map pockets, etc. The trim panel generally includes a relatively rigid substrate that provides the structural support and defines the general shape of the trim panel. To improve the aesthetic appearance of the trim panel, a decorative cover material or outer skin layer may be disposed over the front or interior surface of the substrate. For instance, the substrate may be covered with decorative vinyl, cloth, leather and other aesthetically pleasing materials. Foam padding may be further provided between the substrate and the decorative cover to provide a soft, cushy feel to the trim panel.

For many automotive trim panels, it is common to include a turn down flange along a top edge of the trim panel where, for instance, the trim panel meets the window of the door. The turn down flange prevents the upper edge of the trim panel from being visible and accessible to the vehicle occupants. Moreover, the turn down flange may provide a surface for mounting the trim panel to the door frame, such as with fasteners known in the art. The turn down flange may further provide a surface for coupling with the door window seal, which prevents or reduces the ingress of air, water, moisture and road noise into the interior of the vehicle. The turn down flange is typically integrally formed with the substrate and the cover is wrapped around the flange to secure the cover with the substrate.

Trim panels having the above construction, however, have some drawbacks. One primary drawback is in the manufacturing of the trim panel. For example, trim panels having a wrapped turn down flange are generally manufactured by first forming a trim panel without the turn down flange, and then forming the turn down flange in a separate processing step. For instance, a low pressure injection molding process may be used to form the rigid substrate and cover material bonded thereto without a turn down flange. The trim panel is then removed from the mold and in a separate processing step, a portion of the trim panel is reheated so as to bend the portion of the trim panel to form the wrapped turn down flange. The portion of the substrate that subsequently forms the turn down flange may include bend lines to facilitate the bending of the substrate and formation of the turn down flange. In an alternate method, similar to that described above, the turn down flange may be formed in the low pressure injection molding process but the cover member not bonded with the substrate along the turn down flange portion. Once the trim panel is removed from the mold, the cover material is then wrapped, usually by hand, around the turn down flange in a separate processing step. The above-described methods require additional pieces of equipment, additional operators, and additional floor space, which increase the overall cost of making the trim panel. Additionally, the above-described methods have a significant failure rate and other quality issues that further increase the overall costs of making the trim panel.

More recently, several attempts have been made at wrapping the turn down flange with the cover material during the molding process of the substrate. These “in-mold” methods, however, have thus far generally proven unsatisfactory. In one method, for example, an injection/compression molding process is used wherein a cover material is placed in a mold cavity and a mold core positioned so as to mate with the mold cavity. As the mold core is closing, a molten resin material is injected into the mold and compressed by the mold core to distribute the resin throughout the cavity. A slide is provided and is configured to mate with the mold core so as to form the wrapped turn down flange. The slide is timed to engage and mate with the mold core when the mold core substantially reaches its fully closed position near the end of the compression process. This method, however, suffers from the formation of wrinkles in the cover material that have proven difficult to eliminate. Additionally, the flow of the molten resin material into and through the mold cavity must be precisely controlled such that the resin material does not reach the flange area during the compression process before the slide is mated with the mold core. Such precise control of the resin flow is difficult to maintain, which results in an increased number of rejected parts and other quality issues.

Another in-mold method that has generally proven unsatisfactory includes a closed mold injection process. In this method, the mold is closed completely and the slide is mated with the mold core prior to injecting the resin material into the mold cavity. In this method, however, the high temperature of the resin material at the injection site, i.e., at the point the resin is introduced into the mold, causes marking of the visible side of the cover material. This is especially true when the cover material includes a foam layer, which cannot withstand the high temperatures of the injected resin. Thus, to use this method, the injection site must be in a non-show area of the trim panel, such as an area that will be subsequently covered by another trim component. Alternatively, a tri-laminate cover material may be used as a cover material. Nevertheless in many instances, even with the tri-laminate cover material, there may be markings on the visible surface of the cover material.

There is thus a need for an improved apparatus and method of making a trim panel having a wrapped turn down flange that reduces tooling requirements, manufacturing steps and labor necessary for assembly thereof, thereby reducing overall manufacturing costs.

### SUMMARY OF THE INVENTION

The present invention provides an apparatus and method of forming an automotive door trim panel having a wrapped turn down flange through an in-mold process that overcomes these and other shortcomings of the previous methods. A mold assembly for forming the automotive trim panel includes a first mold section having a mold cavity that defines at least a portion of the door trim panel. A mold core is positioned in confronting relation with the mold cavity of the first mold section and is adapted to cooperate with the first mold section to form the door trim panel. The mold core is moveable relative to the first mold section so as to move toward and away from the mold cavity. The mold assembly also includes a flange lifter having a recess that is capable of independent movement relative to the mold core and the first mold section. The flange lifter is adapted to cooperate with the first mold section to define a first mold chamber portion therebetween. The mold assembly further includes a flange slide that is selectively engagable with the flange lifter. At least a portion of the flange slide is adapted to extend within the recess in the flange lifter so as to define a second mold chamber portion in communication with the first mold chamber portion. The second mold chamber portion between the flange lifter and the flange slide is adapted to at least partially define the shape of the turn down flange.

The mold assembly may be advantageously used to form an automotive trim panel having a wrapped turn down flange. In use, a cover material is placed in the mold cavity. The flange lifter is moved adjacent to the mold cavity to a molding position so as to define the first mold chamber portion between the mold cavity and the flange lifter. The flange slide is then moved so as to engage the flange lifter. Movement of the flange slide places the cover material within the recess of the flange lifter and also defines the second mold chamber portion between the flange lifter and the flange slide when they are so engaged. Moreover, the engagement of the flange slide with the flange lifter may further prevent movement of the flange lifter relative to the mold cavity and, as such, operate as a locking mechanism between the flange lifter and the first mold section. Once the flange slide and flange lifter have been engaged, and with the mold core and mold cavity defining an expanded mold chamber portion, a polymeric material is injected into the mold assembly. The mold core is then moved relative to the mold cavity to compress the polyermic material and distribute the material throughout the first and second mold chamber portions so as to form the turn down flange having the cover material wrapped thereabout.

In one exemplary embodiment, the flange lifter is formed as an assembly with the mold core. Nevertheless, because the flange lifter can move independently of the mold core, the flange lifter may be moved to its molding position, to define the first mold chamber portion, while the mold core and mold cavity define the expanded mold chamber portion. This then allows the mold core sufficient space to move so as to compress the polymeric material and distribute the material throughout the cavity and the first and second mold chamber portions. Moreover, independent movement of the flange lifter relative to the mold core also allows the flange slide to be engaged with the flange lifter, so as to define the second mold chamber portion, prior to the mold core compressing the polymeric material. Additionally, because the mold core may move independently of the flange lifter, during the compression of the polymeric material, the flange lifter may be fixed with respect to the mold cavity so that movement of the mold core does not move the flange lifter.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a front view of a door trim panel made in accordance with the invention fastened to a vehicle door frame;

FIG. 2 is a diagrammatic cross-sectional view illustrating a mold assembly in an initial position and containing a cover material for forming a trim panel in accordance with the invention;

FIG. 3 is a diagrammatic cross-sectional view similar to FIG. 2, but illustrating a further process step of closing the mold so that the flange lifter is in a molding position and the mold core defines an expanded mold chamber portion;

FIG. 4 is a diagrammatic cross-sectional view similar to FIG. 3, but illustrating a further process step of engaging the flange slide with the flange lifter, injecting a polymer material into the mold and compressing the material with the mold core;

FIG. 5 is a diagrammatic cross-sectional view similar to FIG. 4, but illustrating the end of the compression process that distributes the material throughout the mold to form the trim panel having a wrapped turn down flange;

FIG. 6 is a diagrammatic cross-sectional view similar to FIG. 5, but illustrating a further process step of disengaging the flange slide from the flange lifter; and

FIG. 7 is a diagrammatic cross-sectional view similar to FIG. 6, but illustrating a further process step of removing the trim panel from the mold cavity and mold core.

### DETAILED DESCRIPTION OF THE DRAWINGS

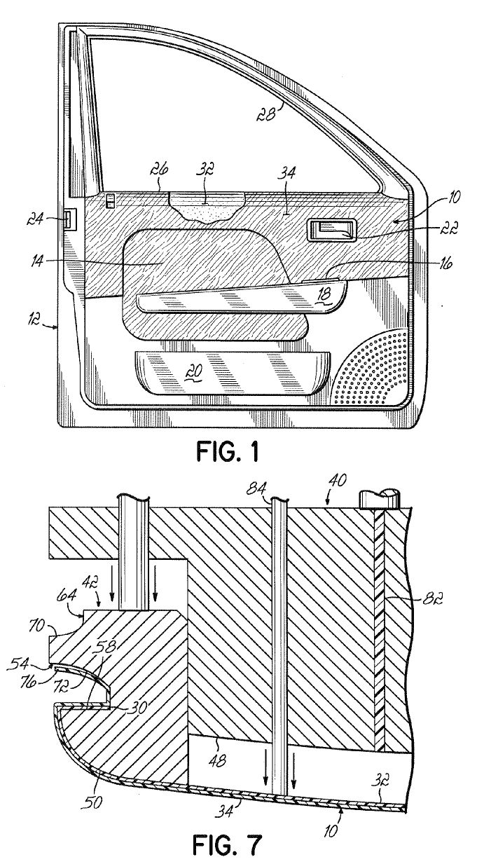

With reference to FIG. 1, a door trim panel 10 constructed in accordance with an embodiment of the invention is fastened to a door of a vehicle such as, for example, an automobile, a truck, or an aircraft. More specifically, door trim panel 10 is coupled with, and inboard of, the inner sheet metal of a door frame 12, which has a hinged attachment with a body of a vehicle (not shown). However, persons of ordinary skill in the art will appreciate that door trim panel 10 may be used on other doors including but not limited to sliding doors, hatches, etc. Further, persons of ordinary skill in the art will also appreciate that door frame 12 may be constructed of other materials such as composites like fiberglass and carbon fibers. A passenger occupying the passenger cabin of the vehicle can manually move the assembled door relative to the vehicle body for passenger ingress and egress of the passenger cabin.

The door trim panel 10 is coupled by fasteners with door frame 12 and includes various trim components thereon including a bolster 14, a switch bezel 16, an armrest 18, and a map pocket 20. Switch bezel 16 includes electrical control panels (not shown) that carry control switches that are electrically coupled by a hidden wire harness with conventional electrically-operated components such as door locks, window controls, seat controls, and side mirrors of the automobile. An inner door release handle 22 for operating a door latch 24 is also accessible to a passenger inside the passenger cabin. The trim components may be integrally formed with trim panel 10 or provided as separate components and coupled to trim panel 10 as an assembly.

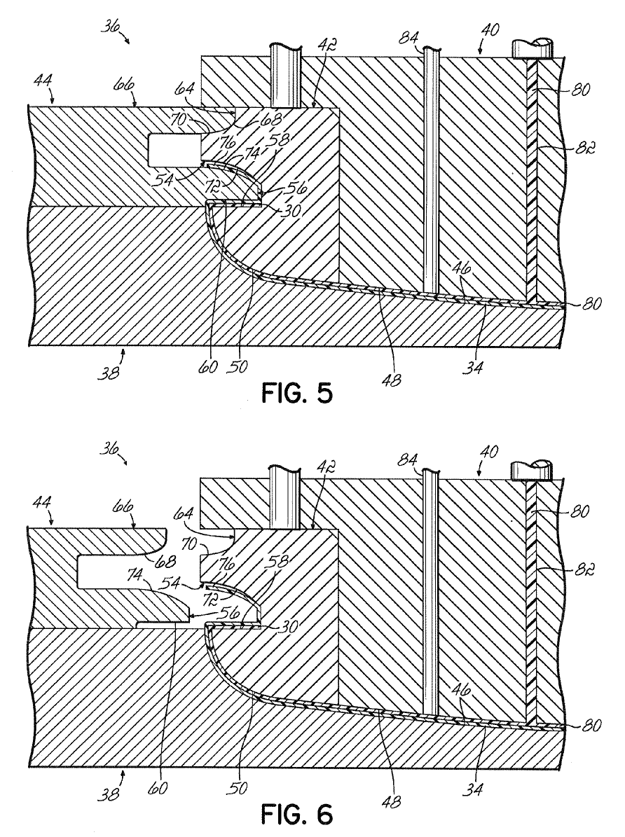

Trim panel 10 includes a top edge 26 that, as shown in FIG. 1, abuts the door frame 12 adjacent the window opening 28. Top edge 26 includes a turn down flange 30 (FIGS. 5-7) that is not visible by vehicle occupants when the trim panel 10 is mounted to the door frame 12. Turn down flange 30 provides a surface for connecting the top edge 26 of trim panel 10 to the door frame 12. Turn down flange 30 further provides a surface for coupling with a window seal (not shown).

Trim panel 10 includes a relatively rigid substrate 32, which forms at least a portion of the structural support and defines the general shape of the trim panel 10. The substrate 32 may be made from a polymer material, such as a structurally rigid thermoplastic or thermoset polymer material like a thermoplastic polyolefin (e.g. polypropylene). The trim panel 10 further includes a cover material 34 that is disposed over an interior surface of the substrate 32 to provide a decorative and aesthetically pleasing appearance to the trim panel 10. To this end, the cover material 34 may be wrapped around the turn down flange 30 to secure the cover material 34 with the substrate 32. The cover material may, for example, be cloth, vinyl, leather or other material coverings known in the art. For instance, a foamed thermoplastic or thermoset polymer material, like foamed polypropylene, may be used as a suitable cover material. Those of ordinary skill in the art will recognize other materials that may be used as the cover material 34 for the invention. Those of ordinary skill in the art will also recognize that the substrate material and cover material may be selected to provide, for example, good bonding between the substrate 32 and cover material 34 during the molding process.

FIGS. 2-7 show an exemplary molding assembly 36 for forming the trim panel 10 having a wrapped turn down flange 30 as described above. The molding assembly 36 includes a first mold section 38, a moveable mold core 40, a flange lifter 42 and a flange slide 44. The first mold section 38 includes a mold cavity 46 that defines at least a portion of the shape of the trim panel 10. The mold core 40 includes a molding surface 48 that confronts a portion of mold cavity 46. Additionally, mold core 40 is independently moveable relative to the first mold section 38 so as to move molding surface 48 toward and away from mold cavity 46. The flange lifter 42 includes a molding surface 50 that also confronts a portion of mold cavity 48. Likewise, flange lifter 42 is independently moveable relative to the first mold section 38 so as to move molding surface 50 toward and away from mold cavity 46. As shown in FIG. 2, the flange lifter 42 may be formed as an assembly with the mold core 40, although the invention is not so limited.

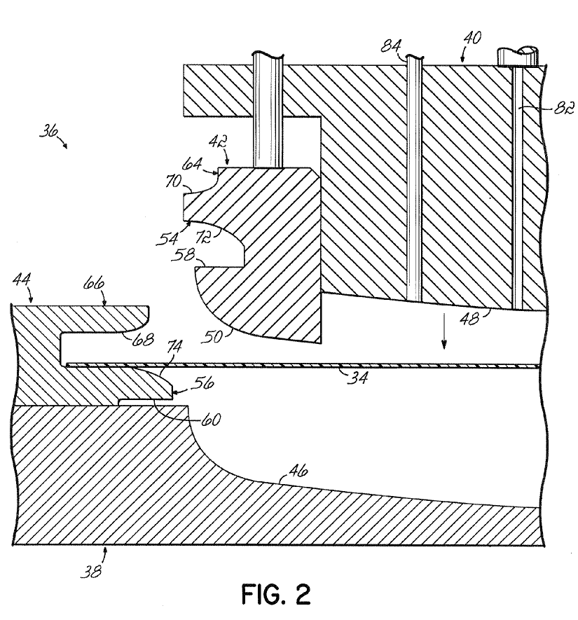

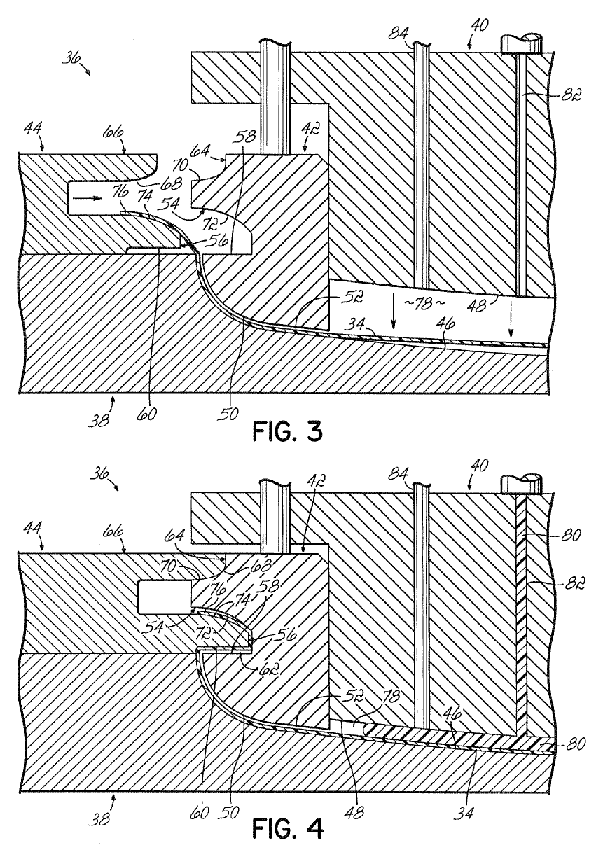

In an advantageous aspect of the invention, the flange lifter 42 is configured to be independently moveable relative to the mold core 40. The mold core 40 is likewise configured to be independently moveable relative to the flange lifter 42. Consequently, the molding surface 50 may be moved toward and away from mold cavity 46 without moving mold core 40. Likewise, the molding surface 48 may be moved toward and away from mold cavity 46 without moving flange lifter 42. For instance, flange lifter 42 may be independently moved relative to mold core 40 to a molding position where molding surface 50 and mold cavity 46 define a first mold chamber portion 52 between the flange lifter 42 and first mold section 38 (FIG. 3). This may be done without moving mold core 40.

Flange lifter 42 further includes a flange recess 54 on an outer surface thereof that, as explained in more detail below, at least partially forms the turn down flange 30 on trim panel 10. To this end, the mold assembly 36 includes a flange slide 44 that is moveable relative to flange lifter 42 and configured to engage flange lifter 42 so as to collectively define the shape of the turn down flange 30. In particular, flange slide 44 includes a projecting portion 56 that may be positioned within flange recess 54. The flange recess 54 includes a first flange forming surface 58 that is continuous with the molding surface 50. The flange slide 44 includes a second flange forming surface 60 that is spaced apart from first flange forming surface 58 when the flange slide 44 is engaged with the flange lifter 42. The first and second flange forming surfaces 58, 60 define a second mold chamber portion 62 between the flange lifter 42 and flange slide 44 when the flange slide 44 is engaged with the flange lifter 42. The second mold chamber portion 62 then at least partially defines the shape of the turn down flange 30 in the mold assembly 36 (FIG. 4).

As will be explained in more detail below, it may be desirable to provide a locking mechanism so as to prevent movement of the flange lifter 42 relative to the first mold section 38 and mold cavity 46 when the flange lifter 42 is placed in the molding position. To this end, the flange lifter 42 may further include a cut out 64 in the outer surface of the flange lifter 42 and flange slide 44 may include a projecting portion 66 that cooperate to lock the position of the flange lifter 42 relative to the first mold section 38. When the flange slide 44 is engaged with the flange lifter 42, a bearing surface 68 on the projecting portion 66 overlies and confronts a complimentary bearing surface 70 in cut out 64. The two bearing surfaces 68, 70 may be in close contact with each other and movement of the flange lifter 42 in a direction away from the first mold section 38 is prevented. Moreover, flange recess 54 may include a bearing surface 72 that cooperates with a bearing surface 74 on projecting portion 56 to prevent movement of flange lifter 42 in a direction toward the first mold section 38 when the flange slide 44 is engaged with the flange lifter 42. The bearing surfaces 72, 74 may be spaced apart to accommodate cover material 34. In this way then, the engagement of the flange slide 44 with the flange lifter 42 not only provides for forming second mold chamber portion 62 for the turn down flange 30 of trim panel 10, but also provides a locking mechanism that prevents movement of the flange lifter 42 relative to the first mold section 38.

FIGS. 2-7 further show an exemplary method of using the mold assembly 36 for forming the trim panel 10 shown in FIG. 1 and described above. In particular, as shown in FIG. 2, with the mold assembly 36 open, i.e., the first mold section 38 and mold core 40, including the flange lifter 42 incorporated therein, spaced apart, the cover material 34 may be positioned in the mold cavity 46. As shown in FIGS. 2 and 3, the cover material 34 is sized so as to have a length 76 that extends outside the mold cavity 46 when the cover material 34 is firmly pressed into the mold cavity 46 by mold core 40 and flange lifter 42. The length 76 may be used to wrap the turn down flange 30. The end of length 76 may be placed on the bearing surface 74 of projecting portion 56. With the cover material 34 in place, the mold assembly 36 is “closed” so that mold core 40 and flange lifter 42 are adjacent the first mold section 38 and molding surfaces 48, 50 confront the mold cavity 46. In this position, the molding surface 48 of mold core 40 and mold cavity 46 define an expanded molding chamber portion 78. Moreover, when the mold assembly 36 is closed, the flange lifter 42 may be placed in the molding position so that molding surface 50 and mold cavity 46 define the first mold chamber portion 52. For instance, the flange lifter 42 may be independently moved relative to mold core 40 prior to closing mold assembly 36 such that the flange lifter 42 is in the molding position when the mold assembly 36 is closed. The invention is not so limited as the flange lifter 42 may be independently moved relative to mold core 40 to the molding position after the mold assembly 36 is closed.

As shown in FIG. 4, with the flange lifter 42 in the molding position, the flange slide 44 is moved so as to engage the flange lifter 42. In particular, as the flange slide 44 engages the flange lifter 42, projecting portion 56 is positioned within flange recess 54 and thus the length 76 of cover material 38 is also positioned within flange recess 54. When the flange slide 44 is engaged with the flange lifter 42, the first and second flange forming surfaces 58, 60 define the second mold chamber portion 62. The second mold chamber portion 62 at least partially defines the shape of the turn down flange 30 and is in communication with the first mold chamber portion 52. As explained above, the flange slide 44 also provides a locking mechanism so as to prevent movement of the flange lifter 42 relative to the first mold section 38 when the flange slide 44 is so engaged.

As shown in FIGS. 4 and 5, after the flange slide 44 is engaged with the flange lifter 42, a polymeric material 80 is injected into the mold assembly 36 and compressed so as to distribute the polymeric material 80 throughout the mold assembly 36. The polymeric material 80 forms the substrate 32 of the trim panel 10. In particular, the polymeric material 80 is injected into the expanded chamber portion 78 via a channel 82 in mold core 40. The mold core 40 is then moved toward the first mold section 38 which compresses the polymeric material 80 and causes the material to spread throughout the first and second mold chamber portions 54, 62. The mold core 40 may be moved toward first mold section 38 until the molding surface 48 and mold cavity 46 define a mold chamber portion that conforms to the desired thickness of the substrate 32. For instance, as shown in FIG. 5, the mold core 40 is moved so that molding surface 48 is aligned with molding surface 50 and a substrate 32 having a uniform thickness results. The invention, however, is not so limited.

As shown in FIGS. 6 and 7, once the polymeric material 80, which now forms substrate 32, has had sufficient time to cure, the flange slide 44 is disengaged from the flange lifter 42. This releases the locking mechanism and allows the flange lifter 42 to be moved relative to the first mold section 38. The mold core 40 and flange lifter 42 are then moved away from the first mold section 38 to open the mold assembly 36 and to remove the formed trim panel 10 from the mold cavity 46. The formed trim panel 10 is then separated from the mold core 40 by independently moving flange lifter 42 away from mold core 40. Additionally, one or more ejector pins 84 may be provided that cooperate with the flange lifter 42 to separate the trim panel 10 from the mold core 40. The trim panel 10 is then removed from flange lifter 42, such as by an assembly line worker, automated means, or other methods known in the art. The trim panel 10 having the in-mold wrapped turn down flange 30 may be subsequently mounted onto the door frame 12 of an automobile, as shown in FIG. 1.

The invention provides a number advantages over the prior methods of making a trim panel having a wrapped turn down flange. In particular, the invention reduces the amount of tooling and operation steps to produce the trim panel by forming the wrapped turn down flange through an in-mold process. For instance, the invention advantageously eliminates a second piece of equipment used to bend the substrate so as to form the turn down flange. The invention further eliminates the processing step and labor necessary to wrap the cover material around the flange.

The invention also provides advantages over the previous in-mold techniques. For instance, because the flange lifter 42 can independently move relative to mold core 40, the flange lifter 42 may be placed in the molding position while the mold core 40 defines an expanded chamber portion 78 with the mold cavity 46. This in turn allows the flange slider 44 to engage the flange lifter 42 so as to form the second mold chamber portion 62, which at least partially defines the shape of the turn down flange 30, prior to compressing the polymeric material 80. In essence, the invention separates the formation of the second mold chamber portion 62 from the compression of the polymeric material 80. Separating these eliminates the timing issues and material control problems seen in previous compression injection molding techniques. Furthermore, because the mold core 40 can independently move relative to the flange lifter 42, and because the flange lifter 42 may be locked by the flange slide 44, the benefits of compression molding may be realized in the invention without marking the visible surface of the cover material, as is the case with previous closed mold injection techniques.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. A mold assembly for forming an automotive door trim panel having a wrapped turn down flange, the mold assembly comprising:
a first mold section having a cavity defining at least a portion of the door trim panel shape;
a mold core adapted to cooperate with said first mold section to form the door trim panel, said mold core moveable relative to said first mold section;
a flange lifter having a recess and independently moveable relative to said mold core and said first mold section, said flange lifter adapted to cooperate with said first mold section to define a first mold chamber portion therebetween; and
a flange slide selectively engagable with said flange lifter, wherein at least a portion of said flange slide is adapted to extend within said recess of said flange lifter when said flange slide is engaged with said flange lifter so as to define a second mold chamber portion in communication with said first mold chamber portion, said second mold chamber portion adapted to at least partially define the shape of the turn down flange.

2. The mold assembly of claim 1, wherein said mold core is independently moveable relative to said flange lifter and adapted to compress a polymeric material disposed within said mold cavity throughout said first and second mold chamber portions.

3. The mold assembly of claim 1, wherein said flange lifter is formed as an assembly with said mold core.

4. The mold assembly of claim 1, wherein said flange lifter and said flange slide are configured such that said flange lifter is prevented from moving relative to said first mold section when said flange slide is engaged with said flange lifter.

5. The mold assembly of claim 1, further comprising:
at least one ejector pin associated with said mold core and moveable relative to said mold core to facilitate separating a formed trim panel from said mold core.

6. A method of forming an automotive door trim panel having a wrapped turn down flange in a mold assembly, the mold assembly including a mold cavity, a mold core, a flange slide, and a flange lifter having a recess for forming the flange on the trim panel, the method comprising:
positioning a cover material in the mold cavity;
moving the flange lifter to a molding position to define a first mold chamber portion between the mold cavity and the flange lifter;
moving the slide to engage the flange lifter so as to position the cover material within the recess, the flange lifter and the flange slide defining a second mold chamber portion in communication with the first mold chamber portion, the second mold chamber portion at least partially defining the shape of the turn down flange;
injecting polymeric material into the mold cavity after engaging the flange slide with the flange lifter; and
moving the mold core relative to the mold cavity to compress the polymeric material throughout the first and second mold chamber portions.

7. The method of claim 6, wherein moving the flange lifter to a molding position further comprises:
moving the flange lifter to a molding position independently of moving the mold core.

8. The method of claim 6, wherein moving the mold core further comprises:
moving the mold core relative to the mold cavity independently of moving the flange lifter.

9. The method of claim 6, further comprising:
preventing movement of the flange lifter relative to the mold cavity prior to moving the mold core to compress the polymeric material.

10. The method of claim 9, wherein the flange slide is used to prevent movement of the flange lifter relative to the mold cavity.

11. The method of claim 6, further comprising:
retracting the flange slide away from the flange lifter; and
moving the flange lifter and mold core away from the mold cavity to withdraw the formed trim panel from the mold cavity.

12. The method of claim 11, further comprising:
moving the flange lifter relative to the mold core to separate the trim panel from the mold core.

13. The method of claim 12, further comprising:
moving an ejector pin relative to the mold core to separate the trim panel from the mold core.
